(19) United States
(12) Patent Application Publication
(10) Pub. No.: US 2022/0014145 A1
(43) Pub. Date: Jan. 13, 2022

(54) WATER GUIDER AND PHOTOVOLTAIC MODULE

(71) Applicant: Sungrow Renewables Development Co., Ltd., Hefei (CN)

(72) Inventors: Kepeng Ji, Hefei (CN); Erbin Li, Hefei (CN); Juan Chen, Hefei (CN); Yanna Huang, Hefei (CN); Meng Liu, Hefei (CN)

(73) Assignee: Sungrow Renewables Development Co., Ltd., Hefei (CN)

(21) Appl. No.: 17/368,922

(22) Filed: Jul. 7, 2021

(30) Foreign Application Priority Data
Jul. 8, 2020 (CN) 202021343889.0

(51) Int. Cl. H02S 40/10; H02S 30/10

(52) U.S. Cl. CPC H02S 40/10; H02S 30/10

(57) ABSTRACT

A water guider and a photovoltaic module are provided. The water guider includes a water guiding portion and a water discharge portion. The water guiding portion is provided with a first position limiting portion configured to abut against a frame of the photovoltaic assembly, so that a first gap is formed between the water guiding portion and the frame, to form a water guiding channel. The water discharge portion is provided at an angle with respect to the water guiding portion, a second gap is provided between the water discharge portion and the frame, to form a water discharge channel. The water discharge channel is in communication with the water guiding channel. The water guider employs the capillary principle to effectively discharge water or dust accumulated on the glass layer located at an inner side of the frame out of the frame.

### CROSS REFERENCE TO RELATED APPLICATIONS

This application claims the priority to Chinese Patent Application No. 202021343889.0 titled “WATER GUIDER AND PHOTOVOLTAIC MODULE”, filed with the China National Intellectual Property Administration on Jul. 8, 2020, which is incorporated herein by reference in its entirety.

### FIELD

The present application relates to the technical field of photovoltaic module manufacturing, and in particular to a water guider and a photovoltaic module.

### BACKGROUND

A photovoltaic assembly includes a glass layer and a photovoltaic power generation layer sequentially from top to bottom, and the glass layer and the photovoltaic power generation layer are fixed together by a frame in the circumferential direction. Generally, the frame of the photovoltaic assembly is higher than the glass layer which is at the upper layer, and thus rainwater and dust may easily remain on the glass layer. Since the photovoltaic power generation layer receives light energy from light transmitted through the glass layer, if there is rainwater and dust remain on the glass layer, the rainwater or dust will prevent the light from entering the photovoltaic power generation layer through the glass layer, which affects the power generation of the photovoltaic power generation layer, and thus the function of an antireflection coating of the photovoltaic power generation layer is weakened.

Currently, a conventional way to cope with the accumulation of water or dust on the glass layer is to provide a guiding hole or a water guiding assembly on the photovoltaic assembly. However, in a case that the guiding hole is provided in the frame to discharge accumulated water and dust, the guiding hole is required to be provided in the frame or the glass layer, leading to high requirements on the manufacturing process of the photovoltaic assembly, which is difficult to achieve. Moreover, the guiding hole may easily be blocked by granular dust or other foreign objects, resulting in failing of water drainage. It can be seen that, the conventional manner for discharging the water or dust out of the photovoltaic module has a poor effect, which fails to effectively discharge the accumulated water or dust on the glass layer.

### SUMMARY

An object of the present application is to provide a water guider and a photovoltaic module, to address the technical problems that the water or dust accumulated on the glass layer of the photovoltaic module.

In order to achieve the above object, a water guider configured to drain water or discharge other liquid or solid substances for a photovoltaic assembly is provided according to the present application, including:
a water guiding portion, where the water guiding portion is provided with a first position limiting portion configured to abut against a frame of the photovoltaic assembly, to provide a first gap between the water guiding portion and the frame, and the first gap forms a water guiding channel; and
a water discharge portion arranged at an angle with respect to the water guiding portion, where a second gap is provided between the water discharge portion and the frame, the second gap forms a water discharge channel, and the water discharge channel is in communication with the water guiding channel.

In an embodiment, an inner wall of the water guiding channel has wettability.

In an embodiment, the water discharge portion is provided with a second position limiting portion configured to abut against the frame of the photovoltaic assembly, to allow the second gap to be formed between the water discharge portion and the frame.

In an embodiment, the water discharge portion includes a water discharge surface, the second position limiting portion includes a second raised strip arranged on the water discharge surface, and an end face, away from the water discharge surface, of the second raised strip abuts against the frame.

In an embodiment, the second raised strip extends along a direction in which the water is discharged on the water discharge surface, to divide the water discharge channel into at least two water discharge sub-channels in communication with the water guiding channel, where the water discharge surface discharges the water in a direction away from the water guiding portion.

In an embodiment, the water guiding portion includes a water guiding surface, the first position limiting portion includes at least one first raised strip arranged on the water guiding surface, and an end face, away from the water guiding surface, of the first raised strip abuts against the frame; or, the first position limiting portion includes a position adjusting member, which passes through the water guiding portion to be connected to the frame, or the position adjusting member has one end fitted to the water guiding surface and another end connected to the frame.

In an embodiment, the position adjusting member includes an adjusting screw or an adjusting threaded rod.

In an embodiment, the first raised strip extends along a direction in which water is guided on the water guiding surface, to divide the water guiding channel into at least two water guiding sub-channels, where the water guiding surface guides the water toward the water discharge portion.

In an embodiment, the water guiding surface includes a first water guiding surface and a second water guiding surface, the second water guiding surface has one end connected to the water discharge surface and another end connected to the first water guiding surface; the first water guiding surface is arranged obliquely with respect to the second water guiding surface, to allow the first water guiding surface to be located above the photovoltaic assembly, so that a water guiding port is formed between the first water guiding surface and the photovoltaic assembly.

In an embodiment, the water guider further includes a fixing portion, the water discharge portion has one end connected to the water guiding portion and another end connected to the fixing portion, and a U-shaped opening is defined by the fixing portion, the water guiding portion and the water discharge portion, where the water guider having the U-shaped opening is an elastic member, and the U-shaped opening of the water guider clamps the frame.

A photovoltaic module is further provided according to the present application, including the photovoltaic assembly and the water guider described above, where the water guiding channel with a water guiding port is formed between the water guiding portion of the water guider and a top of the frame of the photovoltaic assembly, and the water guiding port is located on the photovoltaic assembly.

According to the water guider and photovoltaic module in the embodiments of the present application, by providing the first position limiting portion of the water guiding portion, a capillary water guiding channel is directly formed between the water guiding portion and the frame after the water guider is mounted. When there is accumulated water on the glass layer located at an inner side of the frame, the accumulated water is able to flow toward the water discharge portion along the water guiding channel, such that the accumulated water or dust on the inner side of the frame is guided to the water discharge portion, and is further discharged out of the frame.

### BRIEF DESCRIPTION OF THE DRAWINGS

For more clearly illustrating embodiments of the present application or the technical solutions in the conventional technology, drawings referred to for describing the embodiments or the conventional technology will be briefly described hereinafter. Apparently, drawings in the following description are only examples of the present application, and for the person skilled in the art, other drawings may be obtained based on the set drawings without any creative efforts.

FIG. 1 is a perspective structural view showing a water guider according to an embodiment of the present application;

FIG. 2 is a side view of the water guider according to the embodiment of the present application;

FIG. 3 is a schematic view showing the water guider according to the embodiment of the present application in a mounted state;

FIG. 4 is perspective structural view showing a water guider according to another embodiment of the present application; and

FIG. 5 is a schematic view showing the water guider according to the another embodiment of the present application in a mounted state.

### REFERENCE NUMERALS

| | | | |
|---|---|---|---|
| 1 | photovoltaic module, | 11 | photovoltaic power |
| | | | generation layer, |
| 12 | frame, | 121 | upper end face, |
| 122 | lower end face, | 123 | outer side surface, |
| 13 | water guider, | 131 | water guiding portion, |
| 132 | first position limiting | 133 | water guiding surface, |
| | portion, | | |
| 1331 | first water guiding surface, | 1332 | second water guiding |
| | | | surface, |
| 137 | water guiding channel, | 134 | water discharge portion, |
| 135 | second position limiting | 136 | water discharge channel, |
| | portion, | | |
| 138 | water discharge surface, | 139 | fixing portion, |
| 14 | glass layer. | | |

### DETAILED DESCRIPTION OF THE EMBODIMENTS

Technical solutions according to the embodiments of the present application will be described clearly and completely as follows in conjunction with the accompany drawings in the embodiments of the present application. It is obvious that the described embodiments are only a part of the embodiments according to the present application, rather than all of the embodiments. All the other embodiments obtained by those skilled in the art based on the embodiments in the present application without any creative work belong to the scope of protection of the present application.

It should be noted that, all directional indicators (such as up, down, left, right, front, back . . . ) in the embodiments of the present application are only used for explaining a relative position relationship and movement situation among components in a certain specific posture (as shown in the drawings). If the specific posture changes, the directional indicators will change accordingly.

In addition, the terms “first” and “second” in the embodiments of the present application are only used for descriptive purposes, and cannot be understood as indicating or implying its relative importance or implicitly indicating the number of the indicated technical features. Therefore, the features defined with “first” and “second” may include at least one of the features explicitly or implicitly. In addition, the technical solutions of the embodiments can be combined with each other on the basis that the combination of the technical solutions can be implemented by the person skilled in the art. When the technical solutions are contradictory or the combination of the technical solutions be implemented, it should be considered that such a combination of technical solutions does not exist, and is not within the protection scope of the present application.

A water guider applicable to a photovoltaic assembly is provided according to the present application. The water guider is used to drain water or discharge other liquid or solid substances for the photovoltaic assembly. Specifically, the water guider is mounted on a frame of the photovoltaic assembly.

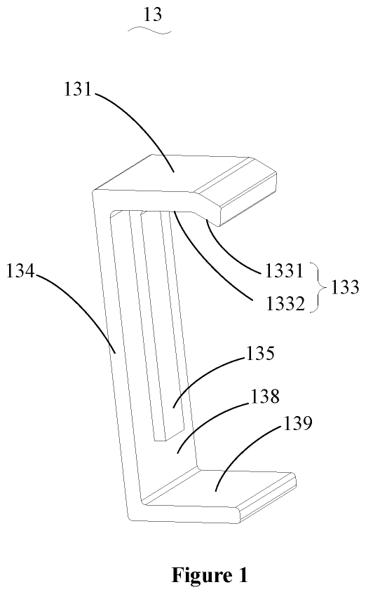

Referring to FIGS. 1, 2, 3 and 5, the water guider 13 includes a water guiding portion 131 and a water discharge portion 134. The water guiding portion 131 is provided at an angle with respect to the water discharge portion 134, and the angle between the water guiding portion 131 and the water discharge portion 134 is smaller than 180 degrees.

In the embodiment, the water guider 13 is applied to the photovoltaic assembly, to discharge water or other substances for the photovoltaic assembly. The water guider 13 is used to cooperate with the photovoltaic assembly, to realize the function of discharging water or other substances. It should be noted here that, the photovoltaic assembly includes a frame 12, a glass layer 14 and a photovoltaic power generation layer 11. The glass layer 14 is located above the photovoltaic power generation layer 11, and both the glass layer 14 and the photovoltaic power generation layer 11 are mounted in the frame 12. An end face of the frame 12 located on the same side of the glass layer 14 is defined as an upper end face 121, and another end surface that is opposite to the upper end face 121 is defined as a lower end face 122. A surface located between the upper end face 121 and the lower end face 122 and outside the frame 12 is defined as an outer side face 123; and a surface for mounting the glass layer 14 and the photovoltaic power generation layer 11 is defined as an inner side face.

When the water guider 13 is mounted on the frame 12, the water guiding portion 131 is located on the upper end face 121 of the frame 12. One end of the water guiding portion 131 is located on the glass layer 14 at an inner side face of the frame 12, and another end of the water guiding portion 131 extends toward the outer side face 123 of the frame 12. The water discharge portion 134 is connected to the another end of the water guiding portion 131, which is away from the glass layer 14. The angle between the water guiding portion 131 and the water discharge portion 134 is smaller than 180 degrees, specifically, the angle may be 90 degrees, or may be any arbitrary value greater than 90 degrees and smaller than 180 degrees. In order to facilitate the production of the water guider 13 and simplify the manufacturing process, the water discharge portion 134 is arranged perpendicular to the water guiding portion 131. Or, in order to improve the guiding effect and mounting accuracy of the water guider 13, the angle between the water guiding portion 131 and the water discharge portion 134 is disposed to be adapted to the angle between the upper end face 121 and the outer side face 123 of the frame 12, so that the water guider 13 is able to fit with the frame 12 when being mounted.

In the embodiment, the water guiding portion 131 is provided with a first position limiting portion 132 configured to abut against the frame 12 of the photovoltaic assembly, to provide a first gap between the water guiding portion 131 and the frame 12, to form a water guiding channel 137. Specifically, the first position limiting portion 132 abuts against the upper end face 121 of the frame 12, such that the water guiding channel 137 is formed on the upper end face 121 of the frame 12. The water guiding portion 131 and the water discharge portion 134 are provided at an angle with respect to each other, a second gap is formed between the water discharge portion 134 and the frame 12, to form a water discharge channel 136 in communication with the water guiding channel 137. In this way, the water guiding portion 131 discharges accumulated water or dust in the frame 12 into the water discharge channel 136 via the water guiding channel 137, and the accumulated water or dust is further discharged out of the frame 12 through the water discharge channel 136.

Specifically, the water guider 13 is mounted on the frame 12 of the photovoltaic assembly, the water guiding portion 131 is located on the upper end face 121 of the frame 12, to form the water guiding channel 137 with the upper end face 121 of the frame 12; and the water discharge portion 134 is located on the outer side face 123 of the frame 12, to form the water discharge channel 136 with the outer side face 123 of the frame 12. Thus, the accumulated water or other substances in the frame 12 and on the glass layer 14, is guided into the water discharge channel 136 via the water guiding channel 137, and is further discharged out of the frame 12 via the water discharge channel 136, to realize the discharge of the water or dust accumulated in the photovoltaic assembly.

It should be noted that, the water guiding channel 137 of the water guider 13 according to this embodiment employs the capillary principle, to guide the accumulated water to the water discharge channel 136 via the water guiding portion 131. Specifically, by providing the first position limiting portion 132 of the water guiding portion 131, when the water guider 13 is mounted on the frame 12, the capillary water guiding channel 137 is formed by the first gap between the water guiding portion 131 and the frame 12. When there is accumulated water on the glass layer 14 located at the inner side of in the frame 12, the accumulated water flows along the water guiding channel 137 toward the water discharge channel 136, such that the accumulated water on the glass layer 14 and in the frame 12 is sucked into the water guiding portion 131 and further guided to the water discharge portion 134. Since the water discharge portion 134 is provided at an angle with respect to the water guiding portion 131, after the water is guided to the water discharge portion 134, the water flows into the water discharge channel 136 and further flows out of the frame 12 due to an action of gravity. Since the water guider 13 according to this embodiment employs the capillary principle to suck the water, which has a certain water suction ability, compared with a manner of directly providing a guiding hole to discharge the water (without water suction ability), the water guider 13 according to this embodiment is able to discharge the accumulated water or other substances more effectively.

In addition, since a size of the water channel, including the water guiding channel 137 and the water discharge channel 136, may affect the performance of capillary action, in this embodiment, by providing the first position limiting portion 132, the water guiding channel 137 is directly formed between the water guiding portion 131 and the frame 12 when the water guider 13 is mounted, which prevents the size of the water guiding channel 137 from being affected by misalignment in mounting, thus improving the mounting accuracy of the water guider 13, and thereby improving the water guiding performance of the water guider 13.

It can be understood that, the water guider 13 in the embodiment may be fixed by an adhesive or a screw, or, the water guider 13 is a U-shaped water guider 13, and is also an elastic member, which may clamp the frame 12 by an elastic force thereof. Specifically, the water guider 13 further includes a fixing portion 139, the water discharge portion 134 has one end connected to the water guiding portion 131 and another end connected to the fixing portion 139, a U-shaped opening is defined by the fixing portion 139, the water guiding portion 131 and the water discharge portion 134, and the U-shaped opening of the water guider 13 is configured to clamp the frame 12.

Specifically, when the water guider 13 is mounted on the photovoltaic assembly, the water guiding portion 131 of the water guider 13 abuts against the upper end face 121 of the frame 12, and the water discharge portion 134 abuts against the outer side face 123 of the frame 12, and the fixing portion 139 abuts against the lower end face 122 of the frame 12. Thus, by providing an opening size of the U-shaped opening to be less than or equal to a height of the frame 12, the water guider 13 is able to clamp the frame 12 to be fixed to the frame 12. The water guider 13 is provided in a U-shaped structure, and the first position limiting portion 132 is provided to limit the position, which simplifies the structure and the mounting process of the water guider 13 while ensuring that the water guiding channel 137 of the water guider 13 meets the requirements of the capillary action.

In a further embodiment, an inner wall of the water guider 13 has wettability, for example, the inner wall of the water guiding channel 137 is made of a wettable material, so that the inner wall of the water guiding channel 137has wettability. Due to the wettability of the inner wall of the water guiding channel 137, the accumulated water on the inner side of the frame 12 flows along the inner wall of the water guiding channel 137 toward the water discharge portion 134. The water guiding channel 137 with wettability has a better water guiding effect.

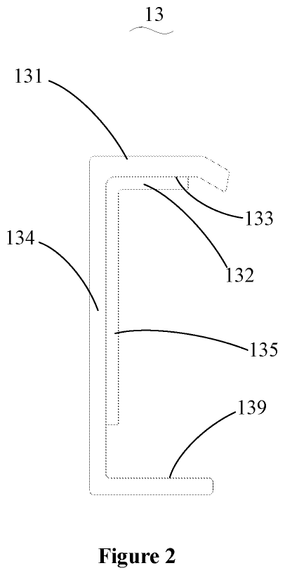

In an embodiment, referring to FIGS. 1 and 2, the water guiding portion 131 includes a water guiding surface 133. The first position limiting portion 132 includes at least one first raised strip (not marked in the figure), and an end face, away from the water guiding surface 133, of the first raised strip abuts against the frame 12.

Specifically, the water guiding portion 131 is a water guiding plate. One side of the water guiding plate is defined as the water guiding surface 133, and the first raised strip is arranged on the water guiding surface 133. Thus, when the water guider 13 is mounted on the frame 12, the first raised strip abuts against the frame 12, and the water guiding channel 137 is formed between the water guiding surface 133 and the frame 12. A height by which the first raised strip protrudes with respect to the water guiding surface 133 is embodied as a width of the water guiding channel 137.

It can be understood that, an area occupied by the first raised strip on the water guiding surface 133 is smaller than an area of the water guiding surface 133. The water guiding surface 133 may be provided with one first raised strip, and the first raised strip is arranged at any position of the water guiding surface 133. Alternatively, the water guiding surface 133 may be provided with multiple first raised strips with a small length, the multiple first raised strips are arranged at intervals or in a staggered manner, and the multiple first raised strips are capable of keeping the water guider stable at all times.

In a further embodiment, the first raised strip is arranged at a middle position of the water guiding surface 133, and the first raised strip extends along a direction in which the water is discharged on the water guiding surface 133, to divide water discharge channel 137 into at least two water guiding sub-channels, where the water guiding surface 133 discharges the water toward the water discharge surface 138.

That is, the first raised strip is provided at the middle position of the water guiding surface 133, and the first raised strip divides the water guiding channel 137 into two open-type water guiding sub-channels. That is, each of the water guiding sub-channels is defined by the water guiding surface 133, the first raised strip and the frame 12, and is open on one side. In this embodiment, since the water guiding channel 137 is open on the side of each of the water guiding sub-channels, if there are substances with large particle sizes on the glass layer 14 of the photovoltaic assembly, they can be discharged through openings of the water guiding channel 137, which facilitates manual cleaning, and thereby effectively preventing the water guiding channel 137 from being blocked.

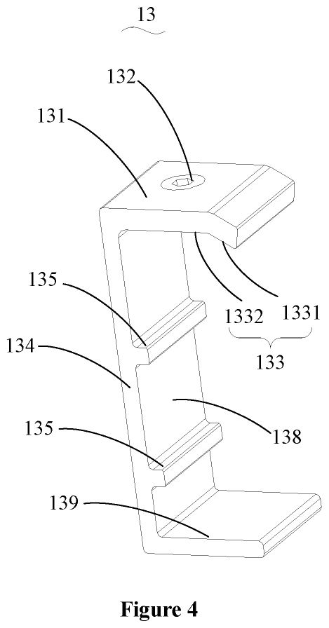

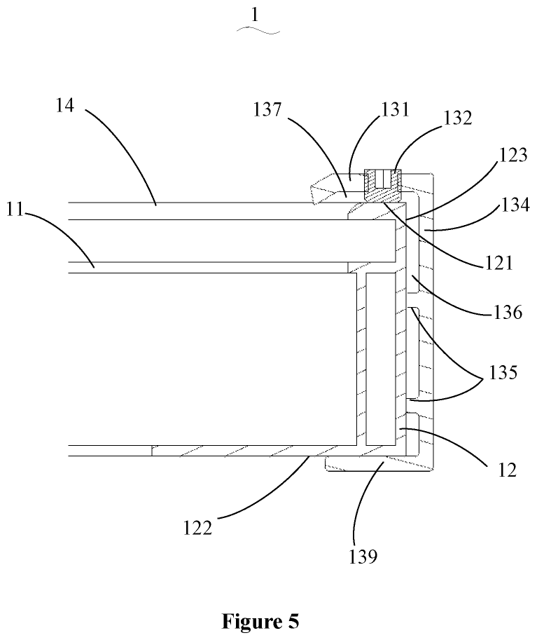

Or, in another embodiment, referring to FIGS. 4 and 5, the first position limiting portion 132 includes an position adjusting member (not marked in the figures), and the position adjusting member passes through the water guiding portion 131 to be connected to the frame.

In this embodiment, the position adjusting member is movably connected to the water guiding portion 131, and is able to adjust a size of the first gap between the water guiding surface 133 and the frame 12. Thus, the size of the first gap between the water guiding surface 133 and the frame 12 may be adjusted according to the environment where the photovoltaic assembly is located.

In an embodiment, the position adjusting member includes an adjusting screw or an adjusting threaded rod. A cap end of the adjusting screw is exposed outside the water guiding portion 131, while a threaded end of the adjusting screw passes through the water guiding portion 131, to be connected to the frame 12 on a side where the water guiding surface 133 is located. In this embodiment, the adjusting screw or the adjusting threaded rod is configured to adjust the size of the water guiding channel 137, and to fix the water guider 13.

Further, with continued reference to FIGS. 1 and 4, the water discharge portion 134 in this embodiment is provided with a second position limiting portion 135 configured to abut against the frame 12 of the photovoltaic assembly, so that a second gap is formed between the water discharge portion 134 and the frame 12 to form the water discharge channel 136. Specifically, the second position limiting portion 135 abuts against the outer side face 123 of the frame 12 to form the water discharge channel 136 on the outer side face 123 of the frame 12.

In this embodiment, the water discharge portion 134 is provided with the second position limiting portion 135, so that when the water guider 13 is mounted, a size of the second gap between the water discharge portion 134 and the frame 12 is limited by the second position limiting portion 135. Since the second position limiting portion 135 limits the size of the water discharge channel 136, mounting misalignment of the water discharge channel 136 can be avoided.

In a further embodiment, the water discharge portion 134 includes a water discharge surface 138. The second position limiting portion 135 includes a second raised strip (not marked in the figure) arranged on the water discharge surface 138, and an end face, away from the water discharge surface 138, of the second raised strip abuts against the frame 12.

In this embodiment, an area occupied by the second raised strip on the water discharge surface 138 is smaller than an area of the water discharge surface 138. The second raised strip is provided on the water discharge surface 138, and a height by which the second raised strip protrudes with respect to the water discharge surface 138 is embodied as a width of the water discharge channel 136.

If the water discharge portion 134 is inclined due to external forces during the mounting process, a size of the water discharge channel 136 (for example, the width of the water discharge channel 136) may be inconsistent along the direction in which the water is discharged, which may affect the water discharge effect. In order to keep the size of the water discharge channel 136 always consistent, in an embodiment, the second raised strip extends along a direction in which water is discharged on the water discharge surface 138. Thus, by increasing an abutment area between the second raised strip and the frame 12, the water discharge portion 134 is prevented from being inclined toward the frame 12, which ensures the size of the water discharge channel 136 always consistent.

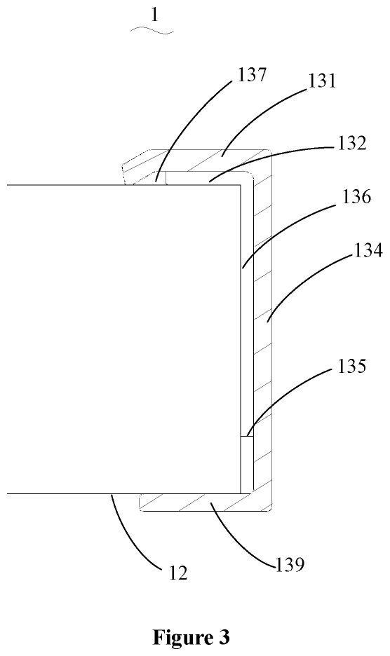

In a preferred embodiment, referring to FIG. 3, the second raised strip is arranged at a middle position of the water discharge surface 138. Thus, the second raised strip divides the water discharge channel 136 into at least two water discharge sub-channels 136 both in communication with the water guiding channel 137. Each of the water discharge sub-channels is open-type. That is, each of the water discharge sub-channels is defined by the water discharge surface 138, the second raised strip and the frame 12, and is open on one side. Since the water discharge channel 136 is open on the side of each of the water discharge sub-channels, which facilitates the discharge of substances with larger particle sizes. It can be seen that, the water guider 13 in this embodiment has a better effect for discharging water and other substances.

In another embodiment, referring to FIG. 4, the second raised strip extends on the water discharge surface 138 in a direction perpendicular to the direction in which the water is discharged, and the water discharge surface 138 is further provided with a third raised strip arranged in parallel with the second raised strip. In this embodiment, balance in mounting the water guider 13 is improved by providing the above two raised strips, which can effectively avoid the inclination in mounting the water guider 13, and thereby avoiding the problem that the size of the water discharge channel 136 is inconsistent along the direction in which the water is discharged.

In a further embodiment, the water guiding surface 133 includes a first water guiding surface 1331 and a second water guiding surface 1332. The second water guiding surface 1332 has one end connected to the water discharge surface 138 and another end connected to the first water guiding surface 1331. The first water guiding surface 1331 is arranged obliquely with respect to the second water guiding surface 1332, to form a water guiding port with the photovoltaic assembly. Where, the first position limiting portion 132 is arranged on the second water guiding surface 1332. Specifically, the first water guiding surface 1331 is located above the glass layer 14 of the photovoltaic assembly.

In this embodiment, the first water guiding surface 1331 is arranged obliquely with respect to the second water guiding surface 1332, such that the first water guiding surface 1331 extends toward the glass layer 14 in the frame 12, to make the water guider 13 be in contact with the accumulated water on the glass layer 14, so as to guide the accumulated water into the water guiding channel 137.

In other embodiments, the first water guiding surface 1331 may be an arc-shaped surface. Thus, the first water guiding surface 1331 is on the glass layer 14, and an arc-shaped water guiding port is formed between the first water guiding surface 1331 and the glass layer 14, which increases a contact area between the water guider 13 and the water, and thereby increasing the water guiding speed.

It can be understood that, the structure of the water guider 13 according to the present application is simple and easy to be implemented. The water guider 13 in this embodiment may also be integrally formed.

A photovoltaic module 1 is further provided according to the present application. Referring to FIGS. 1 to 5, the photovoltaic module 1 includes a photovoltaic assembly and the water guider 13. The photovoltaic assembly includes a photovoltaic power generation layer 11, a glass layer 14, and a frame 12. The glass layer 14 is located above the photovoltaic power generation layer 11, and the glass layer 14 and the photovoltaic power generation layer 11 are mounted in the frame 12. The water guider 13 is mounted on the frame 12, a water guiding channel 137 having a water guiding port is defined by the water guiding portion 131 of the water guider 13 and a top of the frame 12, and a water discharge channel 136 in communication with the water guiding channel 137 is defined by the water discharge portion 134 of the water guider 13 and a side surface of the frame 12. The water guiding port is located on the glass layer 14, to discharge the water or other substances on the glass layer 14 tout of the frame 12 via the water guiding port, the water guiding channel 137 and the water discharge channel 136.

The photovoltaic module 1 in this embodiment employs the water guider 13 according to the above solutions, so the photovoltaic module 1 in this embodiment has all the beneficial effects of the water guider 13 described above.

It should be noted that, in order to accelerate the discharge of the accumulated water on the glass layer 14 of the photovoltaic assembly, the photovoltaic module 1 includes at least two water guiders 13 arranged on the frame 12 at intervals, at the least two water guiders 13 work at the same time to increase the water guiding speed, so that the glass layer 14 of the photovoltaic assembly keeps dry and clean at all times.

The embodiments described hereinabove are only preferred embodiments of the present application, and are not intended to limit the scope of the present application in any form. Although the present application is disclosed by the above preferred embodiments, the preferred embodiments should not be interpreted as a limitation to the present application. For those skilled in the art, many variations, modifications or equivalent replacements may be made to the technical solutions of the present application by using the methods and technical contents disclosed hereinabove, without departing from the scope of the technical solutions of the present application. Therefore, any simple modifications, equivalent replacements and modifications, made to the above embodiments based on the technical essences of the present application without departing from the technical solutions of the present application, are deemed to fall into the scope of the technical solution of the present application.

1. A water guider applicable to a photovoltaic assembly, comprising:
a water guiding portion, wherein the water guiding portion is provided with a first position limiting portion configured to abut against a frame of the photovoltaic assembly, to provide a first gap between the water guiding portion and the frame, and the first gap forms a water guiding channel; and
a water discharge portion arranged at an angle with respect to the water guiding portion, wherein a second gap is provided between the water discharge portion and the frame, the second gap forms a water discharge channel, and the water discharge channel is in communication with the water guiding channel.

2. The water guider according to claim 1, wherein an inner wall of the water guiding channel has wettability.

3. The water guider according to claim 1, wherein
the water discharge portion is provided with a second position limiting portion configured to abut against the frame of the photovoltaic assembly, to allow the second gap to be formed between the water discharge portion and the frame.

4. The water guider according to claim 3, wherein
the water discharge portion comprises a water discharge surface, the second position limiting portion comprises a second raised strip arranged on the water discharge surface, and an end face, away from the water discharge surface, of the second raised strip abuts against the frame.

5. The water guider according to claim 4, wherein
the second raised strip extends along a direction in which water is discharged on the water discharge surface, to divide the water discharge channel into at least two water discharge sub-channels in communication with the water guiding channel, wherein the water discharge surface is configured to discharge the water in a direction away from the water guiding portion.

6. The water guider according to claim 1, wherein
the water guiding portion comprises a water guiding surface; and wherein
the first position limiting portion comprises at least one first raised strip arranged on the water guiding surface, and an end face, away from the water guiding surface, of the first raised strip abuts against the frame; or,
the first position limiting portion comprises a position adjusting member, and wherein the position adjusting member passes through the water guiding portion to be connected to the frame, or the position adjusting member has one end fitted to the water guiding surface and another end connected to the frame.

7. The water guider according to claim 6, wherein
the position adjusting member comprises an adjusting screw or an adjusting threaded rod.

8. The water guider according to claim 6, wherein
the first raised strip extends along a direction in which water is guided on the water guiding surface, to divide the water guiding channel into at least two water guiding sub-channels, wherein the water guiding surface is configured to guide the water toward the water discharge portion.

9. The water guider of claim 6, wherein
the water guiding surface comprises a first water guiding surface and a second water guiding surface, the second water guiding surface has one end connected to the water discharge surface and another end connected to the first water guiding surface; the first water guiding surface is arranged obliquely with respect to the second water guiding surface, to form a water guiding port with the photovoltaic assembly.

10. The water guider according to claim 1, further comprising a fixing portion, wherein
the water discharge portion has one end connected to the water guiding portion and another end connected to the fixing portion, and a U-shaped opening is defined by the fixing portion, the water guiding portion and the water discharge portion; and
the water guider having the U-shaped opening is an elastic member, and the U-shaped opening of the water guider is configured to clamp the frame.

11. A photovoltaic module, comprising the water guider according to claim 1 and the photovoltaic assembly, wherein
the water guiding channel with a water guiding port is formed between the water guiding portion of the water guider and a top of the frame of the photovoltaic assembly, and the water guiding port is located on the photovoltaic assembly.

12. A photovoltaic module, comprising the water guider according to claim 2 and the photovoltaic assembly, wherein
the water guiding channel with a water guiding port is formed between the water guiding portion of the water guider and a top of the frame of the photovoltaic assembly, and the water guiding port is located on the photovoltaic assembly.

13. A photovoltaic module, comprising the water guider according to claim 3 and the photovoltaic assembly, wherein
the water guiding channel with a water guiding port is formed between the water guiding portion of the water guider and a top of the frame of the photovoltaic assembly, and the water guiding port is located on the photovoltaic assembly.

14. A photovoltaic module, comprising the water guider according to claim 4 and the photovoltaic assembly, wherein
the water guiding channel with a water guiding port is formed between the water guiding portion of the water guider and a top of the frame of the photovoltaic assembly, and the water guiding port is located on the photovoltaic assembly.

15. A photovoltaic module, comprising the water guider according to claim 5 and the photovoltaic assembly, wherein
the water guiding channel with a water guiding port is formed between the water guiding portion of the water guider and a top of the frame of the photovoltaic assembly, and the water guiding port is located on the photovoltaic assembly.

16. A photovoltaic module, comprising the water guider according to claim 6 and the photovoltaic assembly, wherein
the water guiding channel with a water guiding port is formed between the water guiding portion of the water guider and a top of the frame of the photovoltaic assembly, and the water guiding port is located on the photovoltaic assembly.
